(19) United States
(12) Patent Application Publication
(10) Pub. No.: US 2006/0218634 A1
(43) Pub. Date: Sep. 28, 2006

(54) System and method for recommending hardware upgrades

(75) Inventors: Sukh M. Sodhi, Boise, ID (US); John D. Egan, Meridian, ID (US); Craig O. Davis, Meridian, ID (US)

Correspondence Address: SCHWEGMAN, LUNDBERG, WOESSNER & KLUTH, P.A., P.O. BOX 2938, MINNEAPOLIS, MN, 55402, US

(73) Assignee: Micron Technology, Inc.

(21) Appl. No.: 11/074,431

(22) Filed: Mar. 8, 2005

(51) Int. Cl. G06F 11/00

(52) U.S. Cl. 726/22

(57) ABSTRACT

A system and method for scanning a personal computer system and making a specific hardware upgrade recommendation is provided. One aspect of this disclosure relates to a method for a client initiated scan and memory upgrade recommendation. According to an embodiment, a user of a personal computer systems is allowed to download a scanner application using a web browser on the user's personal computer system. Scan data is read from the user's personal computer system using the scanner application. The scan data is formatted, encrypted, and returned to the hosting web server. The returned scan data is processed using a recommendation engine and a computer memory upgrade recommendation is outputted to the user's browser. In various embodiments, the recommendation is on a web page displayed on the user's computer system. Other aspects and embodiments are provided herein.

### TECHNICAL FIELD

This disclosure relates to computer systems, and more particularly, to web-based computer scanning systems.

### BACKGROUND

Advances in the field of semiconductor manufacturing have decreased the per unit cost of personal computer systems. The affordability of personal computer systems has made them accessible to an increasingly large segment of the world population. The advent of the internet and electronic mail has made the personal computer system an indispensable part of many homes and small businesses.

Personal computer systems can accommodate a number of hardware configurations (memory such as Dynamic Random Access Memory (DRAM), video cards, etc.). In general, the cost of a personal computer system is directly proportional to the performance of the system. One economical way to obtain increased performance without investing in a new system is to upgrade the hardware in an existing system. For example, adding or replacing one or more DRAM chips in an existing personal computer system can significantly enhance the performance of the system.

Owners and users of personal computer systems, while desirous of optimizing performance of their systems, often are aware that a DRAM upgrade would have a positive impact on performance but are unable to identify the type and/or size of DRAM which would optimize performance of their system.

### SUMMARY

Disclosed herein, among other things, is a method for scanning a computer system and making a specific memory upgrade recommendation. According to an embodiment, a computer system is scanned to determine scan data, including type of computer system, number of available memory slots and amount of existing Dynamic Random Access Memory (DRAM). According to an embodiment, a specific DRAM upgrade is recommended for the computer system based on the scan data. In various embodiments, recommending the specific DRAM upgrade includes displaying a recommendation on a web page on the computer system. In various embodiments, scanning a computer system includes reading data in a system management basic input/output system (SMBIOS) of the personal computer system.

One aspect of this disclosure relates to a method for a client initiated scan and memory upgrade recommendation. According to an embodiment, a user of a personal computer system is allowed to download a scanner application using a web browser on the personal computer system. Scan data is read from the personal computer using the scanner application. The scan data is formatted, encrypted, and returned to the hosting web server. Scan data is processed using a recommendation engine and a computer memory upgrade recommendation is outputted to the user's browser. According to various embodiments, formatting the scan data includes placing the scan data in a format compatible with a markup language. In one embodiment, the scan data is placed in a format compatible with extensible markup language (XML). According to various embodiments, outputting the computer memory upgrade recommendation includes outputting in hypertext markup language (HTML). According to various embodiments, processing scan data through a recommendation engine includes comparing scan data to a database of system memory upgrade data.

One aspect of this disclosure relates to a method for using a server to provide a system upgrade recommendation. According to various embodiments, a user input to request a system scan is accepted. A control is provided to the user to scan the user's system. The results of the scan of the user system are received, and an upgrade of the user system, based on the scan, is recommended. According to various embodiments, the method further comprises receiving information from the user regarding the manufacturer and model of the user system as selected from a drop down menu on a web page, prior to accepting a user input to request a system scan. According to one embodiment, an ActiveX control downloaded from a web server to scan the user system. According to another embodiment, a stand-alone executable program is provided to scan the user system.

Another aspect of this disclosure relates to a computer readable medium encoded with a software program. The software program executes to scan a client computer. According to various embodiments, the software program accepts a user input to request a system scan and initiates a first process to scan a user system to determine a first representation of scan data. The software program then initiates a second process to scan a user system to determine a second representation of scan data. Finally, the software program returns the first and second representations of scan data. According to various embodiments, the first process to scan a user system includes initiating a program to retrieve data from SMBIOS. According to various embodiments, the second process to scan a user system is adapted to obtain scan data from a user system without accessing SMBIOS.

This Summary is an overview of some of the teachings of the present application and is not intended to be an exclusive or exhaustive treatment of the present subject matter. Further details are found in the detailed description and appended claims. Other aspects will be apparent to persons skilled in the art upon reading and understanding the following detailed description and viewing the drawings that form a part thereof, each of which is not to be taken in a limiting sense. The scope of the present invention is defined by the appended claims and their legal equivalents.

### BRIEF DESCRIPTION OF THE DRAWINGS

FIG. 1 illustrates a schematic diagram of a memory upgrade recommendation system, according to various embodiments.

FIG. 2 illustrates a schematic diagram of a client system, according to various embodiments.

FIG. 3A illustrates a schematic diagram of a server system, according to various embodiments.

FIG. 3B illustrates a sequence diagram for a computer scanner and memory upgrade recommendation application, according to various embodiments.

FIG. 4 illustrates a flow diagram of a method for a server to process a client recommendation request, according to various embodiments.

FIG. 5A illustrates a flow diagram of a method for implementing a memory upgrade recommendation system, according to various embodiments.

FIG. 5B illustrates a flow diagram of a method for processing posted data, according to various embodiments.

FIG. 5C illustrates a flow diagram of a method for determining a model match recommendation, according to various embodiments.

FIG. 6 illustrates a flow diagram of a method for making a memory upgrade recommendation, according to various embodiments.

FIG. 7 illustrates a schematic diagram of a representational view of a database used in the recommendation engine application, according to various embodiments.

FIG. 8 illustrates a screen display for the browser-based system of FIG. 1, used to display a recommendation for a specific memory upgrade, according to various embodiments.

FIG. 9A illustrates a screen display for the browser-based system of FIG. 1, used by a customer to directly request a scan, according to various embodiments.

FIG. 9B illustrates a screen display for the browser-based system of FIG. 1, used to request customer acceptance of the scanner license agreement, according to various embodiments.

FIG. 10A illustrates a screen display for the browser-based system of FIG. 1, used to request customer system manufacturer information for a memory advisor tool, according to various embodiments.

FIG. 10B illustrates a screen display for the browser-based system of FIG. 1, used to request customer system product line information for a memory advisor tool, according to various embodiments.

FIG. 10C illustrates a screen display for the browser-based system of FIG. 1, used to request customer system model information for a memory advisor tool, according to various embodiments.

### DETAILED DESCRIPTION

The following detailed description refers to the accompanying drawings which show, by way of illustration, specific aspects and embodiments in which the present invention may be practiced. The various embodiments are not necessarily mutually exclusive, as aspects of one embodiment can be combined with aspects of another embodiment. These embodiments are described in sufficient detail to enable those skilled in the art to practice the invention. Other embodiments may be utilized and structural, logical, and electrical changes may be made without departing from the scope of the present invention.

System Level Overview

Disclosed herein is a system and method for scanning a computer system and making a specific hardware upgrade recommendation based on the scan. In one embodiment, the system is browser-based. The scanned computer system is a client system and the scanning and recommendation software resides on a internet or web server. The web browser of the client downloads the scanner application from the server and executes the scanner application to scan the client system. The data obtained from the scan of the client system is returned to the hosting web server and processed using a recommendation engine that determines a hardware upgrade recommendation for the client system. The recommendation engine steps through several processes to ensure the most accurate hardware upgrade path. In an embodiment, the recommendation appears as a web page on the customer's browser. The disclosed system provides a client or customer with necessary information for improving the performance of the client system, and does not require the client or customer to “look under the hood” of their computer, much less have technical knowledge of computer systems, to acquire this information. In addition, an embodiment of the system allows the client or customer to purchase the recommended hardware directly from the web page displaying the recommendation.

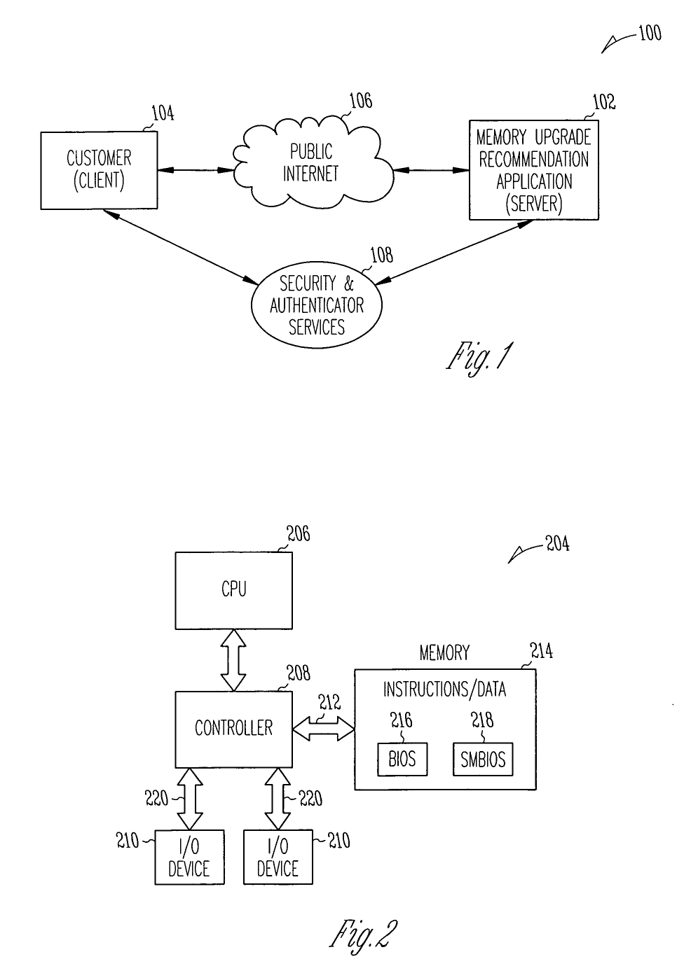

According to various embodiments, the present system and method is used to recommend upgrades of hardware for a personal computer, such as memory, video card or universal service bus (USB) device. FIG. 1 illustrates a schematic diagram of a memory upgrade recommendation system, according to various embodiments. One of ordinary skill in the art will understand that the system and method described, using memory upgrade recommendations as an illustrative example, is equally applicable to recommend other types of hardware upgrades in a computer system. The illustrated system 100 includes a server 102 at a first location and a browser-based client 104 at a second location. The client 104 communicates with the server 102. In one embodiment, the server 102 and client 104 communicate through the public Internet, illustrated as a network cloud at 106. Although only one client 104 and one server 102 are shown, one of ordinary skill in the art will appreciate that the system 100 is able to incorporate a number of clients and a number of servers. Security and authentication services, illustrated at 108, are used to secure the communication between the server 102 and the client 104. Examples of security services include, but are not limited to, firewalls and digital certificates.

In one embodiment, the client 104, illustrated at a customer location, is used to request a scan for a memory upgrade recommendation. In one embodiment, the server 102 is located at or otherwise in communication with a memory upgrade recommendation application such that the server is capable of receiving the request for a scan, providing a control to the client to execute the scan, and providing the requested recommendation.

Client System

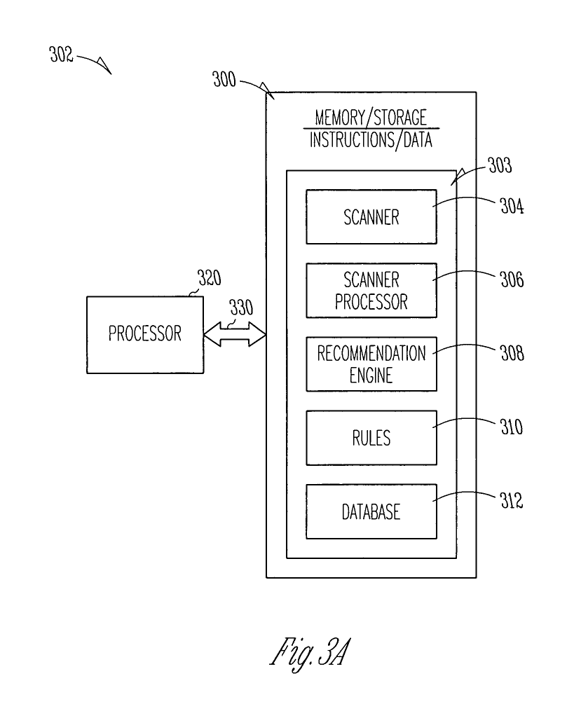

FIG. 2 illustrates a schematic diagram of a client system, according to various embodiments. According to one embodiment, the client system includes a personal computer system. The illustrated client system 204 includes a central processing unit (CPU) 206, a controller 208, input/output (I/O) devices 210, and a memory 214 connected to the controller via a memory bus 212. The illustrated memory 214 holds instructions and data, including basic input/output system (BIOS) data 216 and system management basic input/output system (SMBIOS) data 218.

According to various embodiments, examples of I/O devices 210 include monitors, keyboards, mice, video cards and USB devices. According to various embodiments, the present system and method is adapted to recommend upgrades of I/O devices 210.

Controller 208 produces control and address signals to control the exchange of data between memory 214 and CPU 206, and between memory 214 and peripheral circuitry such as I/O devices 210. This exchange of data is accomplished over memory bus 212 and over I/O bus 220. Coupled to memory bus 212 are a plurality of memory slots which receive memory devices well known to those skilled in the art. For example, single in-line memory modules (SIMMs) and dual in-line memory modules (DIMMs) may be used in various embodiments. These memory devices can be produced in a variety of designs which provide different methods of reading from and writing to the dynamic memory cells of memory slots. One such method is the page mode operation. An alternate type of device is the extended data output (EDO) memory. Other alternative types of devices include SDRAM, DDR SDRAM, SLDRAM and Direct RDRAM as well as others such as SRAM or Flash memories.

According to various embodiments, after powering up the client system, the CPU 206 begins fetching and executing instructions. By convention, the first instruction is located sixteen locations below the top of the memory address space FFFFFF0h (on all x86 based processors). This location belongs to the BIOS Read Only Memory (ROM). BIOS data 216 contains software that determines what a computer can do without accessing programs from a disk. BIOS data 216 provides an initial memory test, initialization of peripheral devices, instructions to create an interrupt vector table, and instructions to boot-up or initialize the operating system. On a personal computer system, BIOS data 216 contains all the code required to control the keyboard, display screen, disk drives and serial communication. SMBIOS data 218 provides information about the system, such as processor information, controller information, memory module information, on board devices information and system slots used. SMBIOS data 218 provides a way for utilities and other programs to access information about a computer system.

Server System

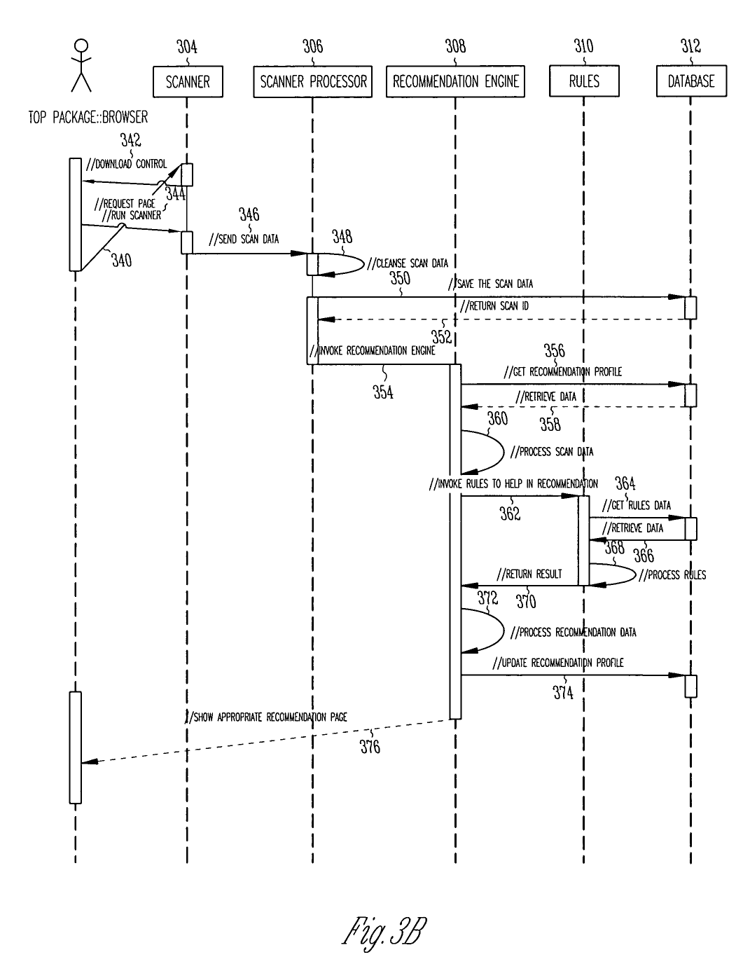

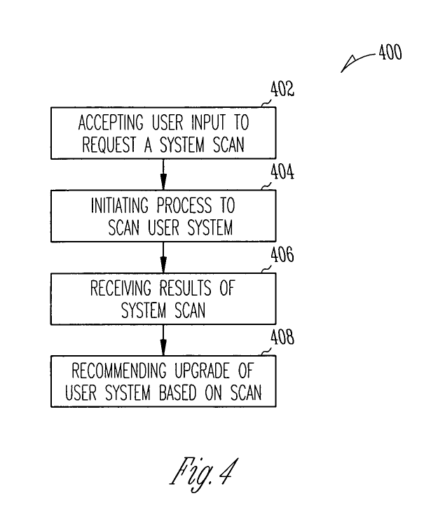

FIG. 3A illustrates a schematic diagram of a server system, according to various embodiments. The illustrated server system 302 includes, among other things, a storage structure or memory 300 and at least one processor 320 that is connected to the memory via a bus 330. The illustrated memory 300 contains, among other things, several program modules for implementing an upgrade recommendation application 303. The upgrade recommendation application 303 includes a scanner module 304, a scanner processor module 306, a recommendation engine module 308, a rules module 310, and a reference database 312. The modules are applications which include instructions operated on by the processor 320 to perform various functions.

FIG. 3B illustrates a sequence diagram for a computer scanner and memory upgrade recommendation application of FIG. 3A, according to various embodiments of the present subject matter. According to an embodiment, the client (such as 104 of FIG. 1) requests a scan from the server (such as 102 of FIG. 1) at 340. The server downloads a control for the scanner 304 at 342, and the scan is executed on the client system at 344. Scan data is returned at 346, and the scanner processor 306 cleanses the scan data at 348. The scan data is saved to the database 312 at 350 and the scan ID is returned at 352.

The recommendation engine 308 is invoked at 354, a recommendation profile is obtained at 356, and data is retrieved from the database 312 at 358. The recommendation engine 308 processes the scan data at 360 and invokes rules 310 to help in the recommendation at 362. Rules data is obtained from the database 312 at 364 and data is retrieved at 366. The rules 310 are processed at 368 and a result is obtained at 370. Recommendation data is processed at 372 and the profile updated at 374 in the database 312. At 376, the recommendation page is displayed on the client system. One of ordinary skill in the art will understand, upon reading and comprehending this disclosure, that there can be a number of ways to implement the application described herein.

Method Implementation

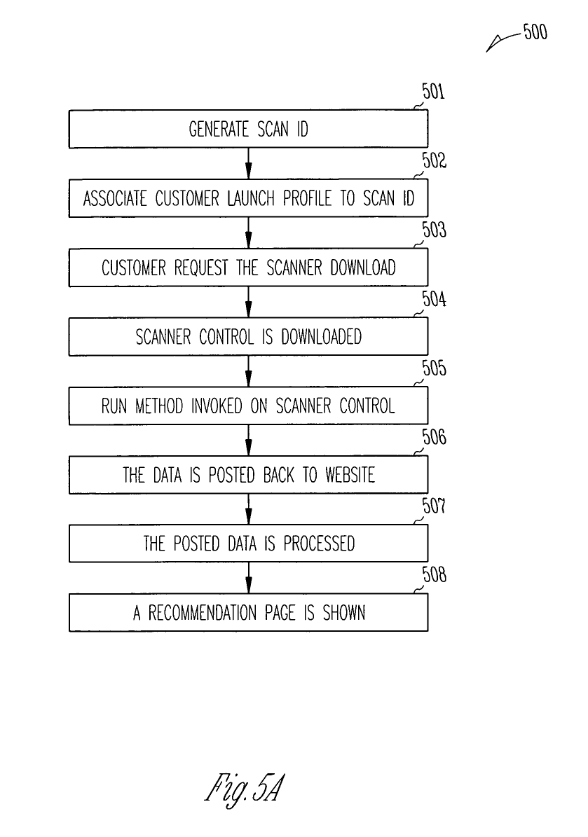

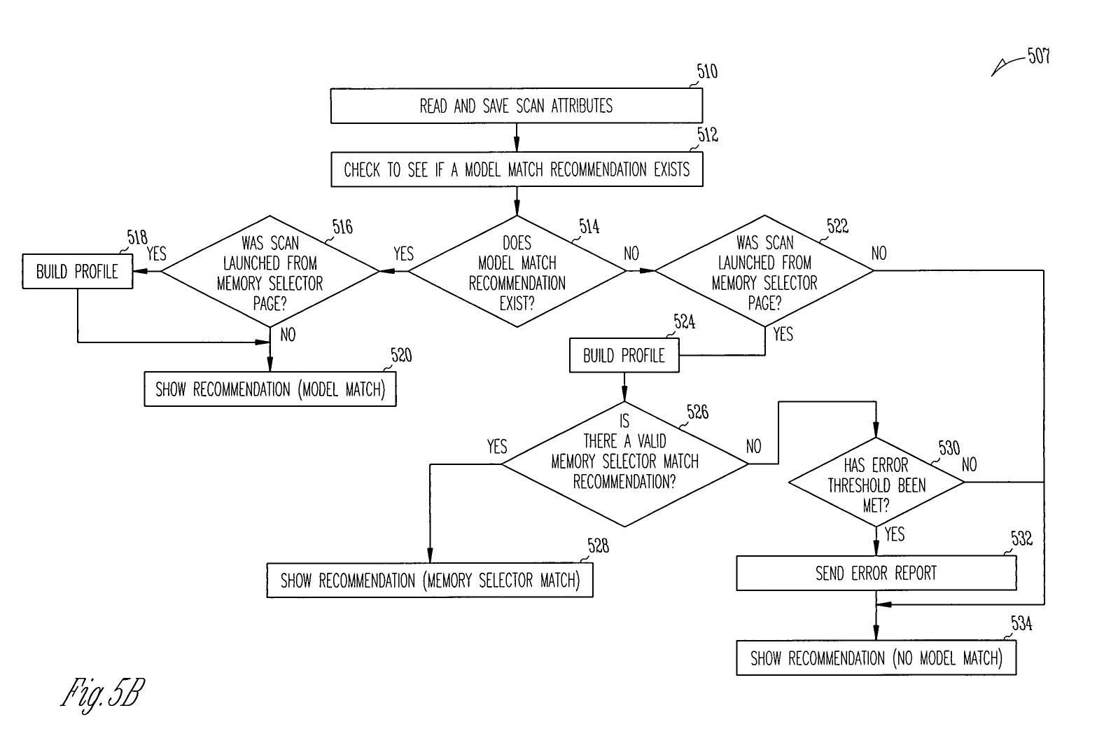

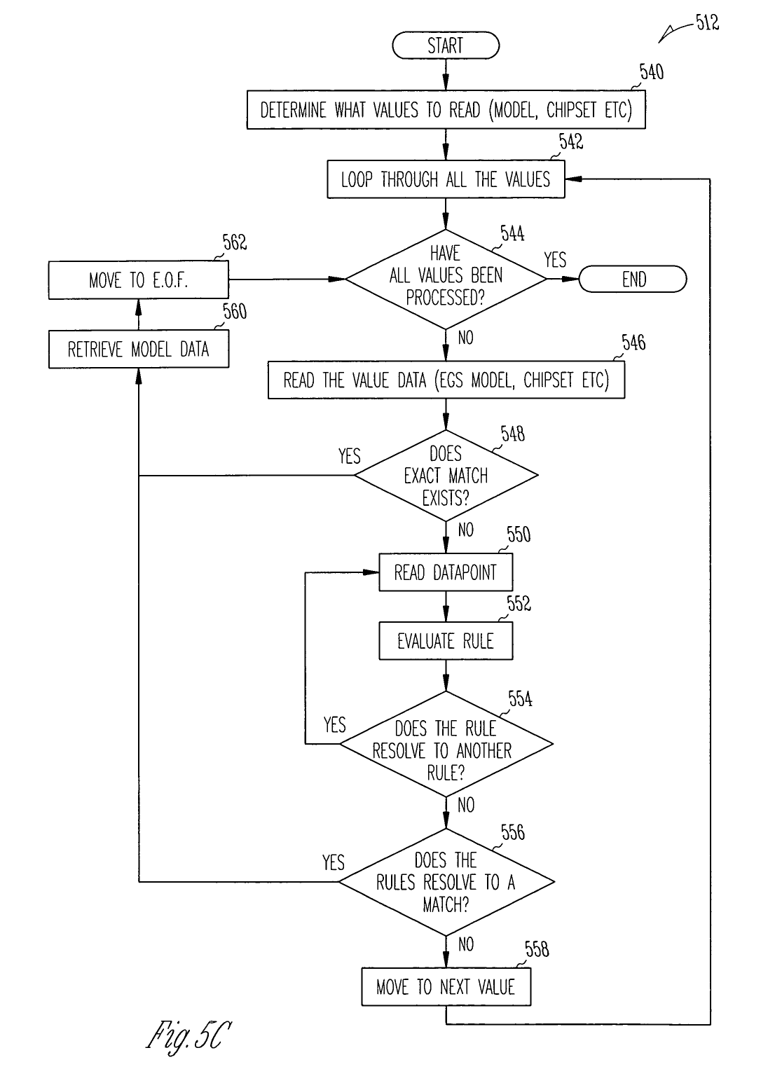

FIG. 4 illustrates a flow diagram of a method for a server to process a client recommendation request, according to various embodiments. According to various embodiments of the method 400, a user input is accepted to request a scan of the user's system at 402. For example, user input can be received from a web browser by allowing a user to click on a link to request a scan. At 404, a process is initiated to scan the user's system. At 406, results of the scan of the user's system are received at the server. At 408, the server returns a recommendation to the user for an upgrade of the user's system, based on the results of the scan. According to various embodiments, the illustrated method is adapted to provide a recommendation for a hardware upgrade. For example, the illustrated method can provide a recommendation for a memory upgrade, as shown in FIGS. 5A through 5C discussed below.

FIG. 5A illustrates a flow diagram of a method for implementing a memory upgrade recommendation system, according to various embodiments. According to various embodiments of the method 500, a scan identification (scan ID) is generated by the server system (such as 102 of FIG. 1) at 501. In various embodiments, the scan ID is a random number generated and used to locate or associate various types and sources of data regarding the user and the user system (aka client system such as 104 of FIG. 1) being scanned. According to various embodiments, the scan ID is saved as a cookie on the user system, and will be used for all further scans of the user system until erased. Types of data associated with the scan ID may include the user's e-mail address and manufacturer and model information regarding the user system, if that information has been made available prior to the scan, such as by selection by the user from a drop down menu. According to various embodiments, a scan can be performed before or after a user selects manufacturer and model information from a drop down menu. If that information is available before the scan, associations between what the user selects and what the scan reports can be made. If there is a high correlation between the scan data and the information provided by the user for a particular model, then the present method will use this to predict a model match for users that have not provided information prior to the scan.

At 502, the customer or user launch profile is associated with the previously generated scan ID by the server system. At 503, the customer or user requests the scanner download. According to various embodiments, the scanner program is integrated into a web page. According to one embodiment, the scanner is an Active X control. Active X controls are a set of rules for how applications should share information. Active X controls have full access to the Windows operating system. According to various embodiments, the scanner program is a stand-alone executable that scans the customer's computer system. According to various embodiments, the scanner program is a Firefox extension. Active X controls can be used for Microsoft Internet Explorer, Firefox extensions can be used for Firefox browsers, and a stand-alone executable is not restricted to a particular browser.

At 504, the scanner control is downloaded to the client system. At 505, the scanner module is launched which scans the customer/client/user system to obtain scan data, or information about the user's system to aid in the memory upgrade recommendation. According to various embodiments, scan data includes the type of computer system, including manufacturer and model, number of available memory slots in the computer system and amount of existing dynamic random access memory (DRAM). According to various embodiments, the scanner is invoked via a scripting programming language. According to one embodiment, the scanner is invoked via JavaScript. JavaScript is a scripting language usually embedded in a hyper text markup language (HTML) page. It consists of lines of executable computer code and was designed to add interactivity to HTML documents.

The scanner operates using a series of gathering rules. According to various embodiments, the gathering rules enable the scanner to obtain all the required information to be processed by the recommendation engine. Specifically, the scanner module scans the user's computer system utilizing one process to scan the system to determine a first representation of scan data. According to various embodiments, the scanner module also scans the user's computer system utilizing a second process to scan the system to determine a second representation of scan data. A first process used to scan the user system executes on a Windows Management Interface (WMI) and searches and records various fields of data from the system's SMBIOS data, according to one embodiment. According to various embodiments, the SMBIOS data fields scanned by the first process include system manufacturer, model, and memory slots available. The number of fields of SMBIOS data scanned can vary. According to various embodiments, between 40 and 150 different fields of SMBIOS data are scanned.

A second process used to scan the user system executes an assembly code routine, according to one embodiment. The second process is used in conjunction with the first process, and is adapted to obtain the necessary scan data from systems that do not have SMBIOS data or that do not support WMI, according to an embodiment. While computer manufacturers are supposed to use SMBIOS to provide a way for utilities to get information about a system, older systems built before about 1998 usually do not implement SMBIOS, and systems built before 2000 can provide inaccurate or inconsistent data. Even new systems can have incorrect SMBIOS data. Additional information is accessed by the second process, such as serial presence detect (SPD) data and operating system data. SPD provides vital information regarding an existing memory module to the system BIOS, such as module density, timing and performance parameters.

The scanner returns scan data gathered from the customer's computer system to the web browser. According to various embodiments, the scan data is returned to the browser in an internet markup language format. According to one embodiment, the scan data is returned to the browser in extensible markup language (XML) format. XML is adapted for documents containing structured information but is more flexible than HTML, since it is not fixed in format and has greater ease of implementation.

At 506, the scan data from the browser is posted back to the website or server. According to various embodiments, the scan data is then processed with the scanner processor to clean up the scan data to ensure it will meet the required format of the recommendation engine. According to various embodiments, the scan data is formatted and encrypted prior to returning from the browser. At 507, the scan data or posted data is processed through the recommendation engine to determine a proper memory upgrade recommendation for the customer's system. At 508, the recommendation is communicated to the customer by displaying a web page on the customer's computer display.

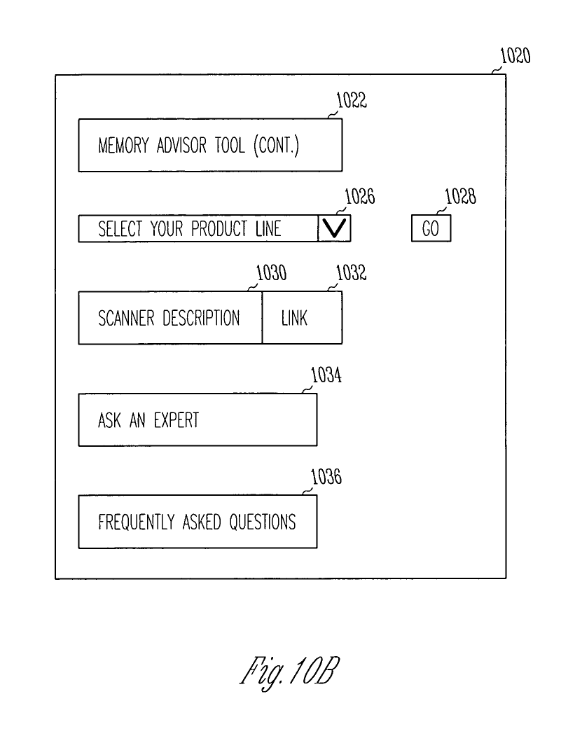

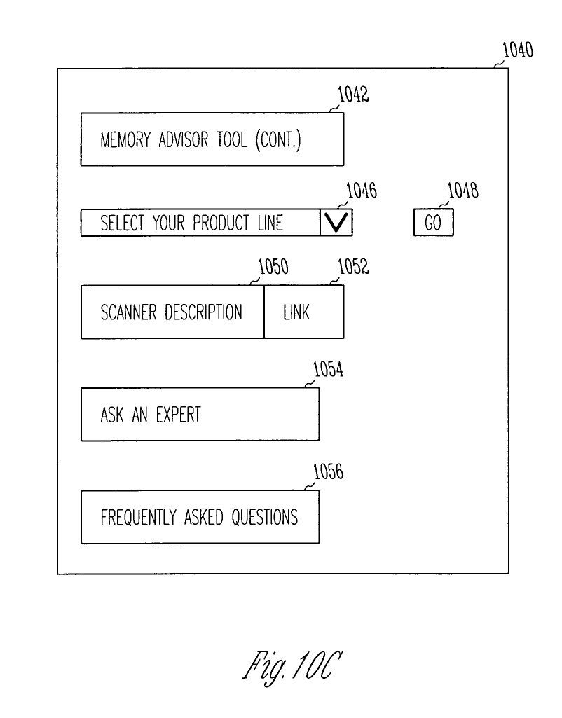

FIG. 5B illustrates a flow diagram of a method for processing posted data, according to various embodiments. FIG. 5B provides further detail for step 507 of FIG. 5A, and explains the processing of the recommendation engine. According to various embodiments of the method 507, scan attributes are read and saved at 510. At 512, a routine is executed to determine if a model match recommendation exists. If a model match recommendation exists 514, step 516 checks if the scan was launched from the memory selector page. Further details regarding the memory selector page can be found in the discussion of FIGS. 10A through 10C below. If the scan was launched from the memory selector page, a profile is built at 518 and then a recommendation is displayed at 520. If the scan was not launched from the memory selector page 516, a recommendation is displayed at 520. If no model match recommendation exists 514, step 522 checks if the scan was launched from the memory selector page. If the scan was not launched from the memory selector page at 522, a recommendation is displayed at 534. If the scan was launched from the memory selector page at 522, a profile is built at 524. At 526, a determination is made whether there is a valid memory selector match recommendation. If so, a recommendation is displayed at 528. If there is no valid memory selector match recommendation, the routine checks to see if an error threshold has been met at 530. According to various embodiments, the error threshold is adjusted to provide a confidence level in making an upgrade recommendation. If the error threshold has not been met at 530, a recommendation is displayed at 534. If the error threshold has been met at 530, an error report is sent at 532 before displaying the recommendation at 534.

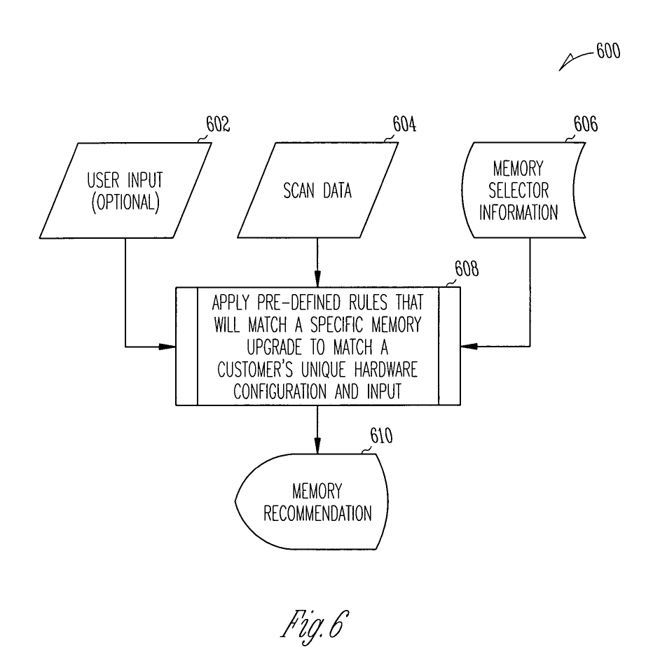

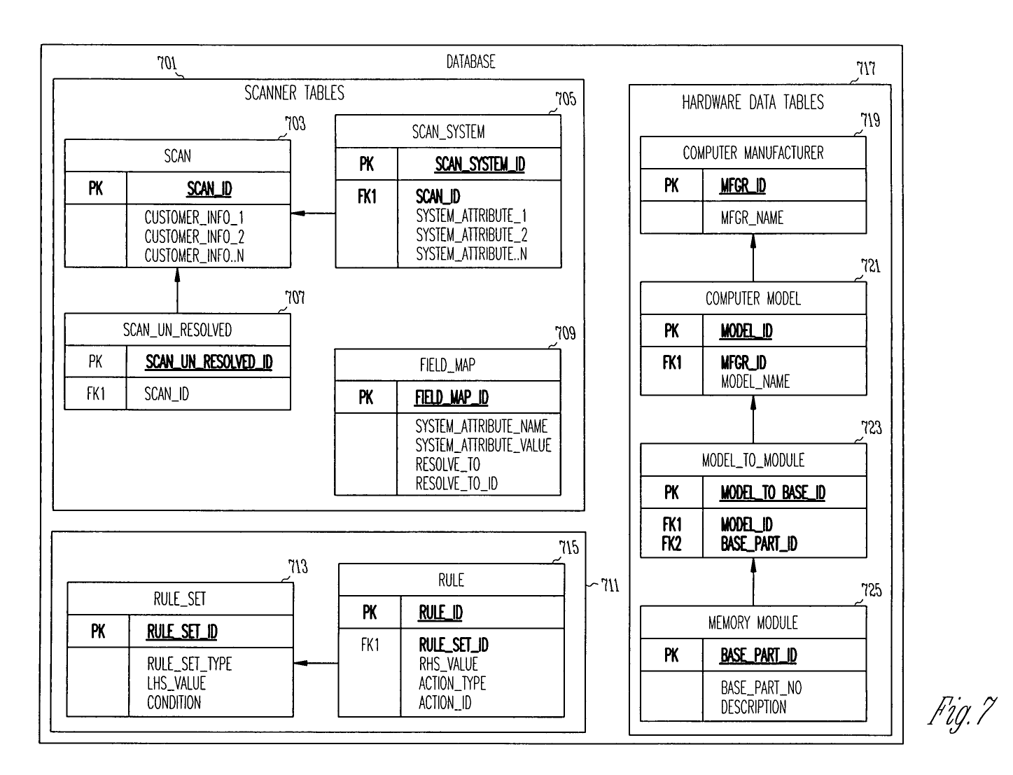

FIG. 5C illustrates a flow diagram of a method for determining a model match recommendation, according to various embodiments. FIG. 5C provides further detail for step 512 of FIG. 5B. Matches are determined by examining specific fields within the returned scan data and comparing to known computer systems already defined in an internal database. Further detail about the database is found in the discussion of FIG. 7 below. According to various embodiments of the method 512, a determination as to which values (model, chipset, etc.) to read is made at 540. At 542, a programming loop is initiated to ensure all values of scanned data have been processed 544. If all values have been processed, the routine ends. If all values have not been processed, the value data (model, chipset, etc.) is read at 546. If an exact match exists at 548, model data is retrieved at 560 and the pointer is moved to the end of the file (EOF) at 562, before returning to 544 to check if all values have been processed. If an exact match does not exist at 548 datapoint is read at 550 and a rule is evaluated at 552. Rules are logic routines created by engineers to assist in obtaining an exact hardware upgrade recommendation based on the available data. Rules are discussed with respect to FIG. 6 below.

If the rule resolves to another rule at 554, the routine returns to 550 to read datapoint. If the rule does not resolve to another rule at 554, a check is made to determine if the rule resolves to a match at 556. If the rule resolves to a match, model data is retrieved at 560 and the pointer is moved to the end of the file (EOF) at 562, before returning to 544 to check if all values have been processed. If the rule does not resolve to a match at 556, the pointer is moved to the next value at 558 and the routine returns to 542 to continue looping through all the values. By looping through all necessary values until a match is found, the recommendation engine has a high probability of successfully matching to a model in the database. If a model match cannot be made, a match is attempted on the motherboard. If a motherboard match cannot be made, a match is attempted on chipset. Using a similar process for the model match, the recommendation engine can further refine the inquiry by looking at additional fields during processing the match attempts for the motherboard and chipset.

According to various embodiments, if no match is found, the recommendation engine will report what is found and allow the user to move forward manually. For example, if the scan is able to determine the computer manufacturer and product line, then a dropdown list of models for that product line would be returned to the user's web browser display. If only the manufacturer is known from the scan, a list of product lines or models for that manufacturer is returned. According to one embodiment, the user can then select their system from the drop down list so that an upgrade recommendation can be made.

According to various embodiments, the scan also collects information about the user system such as current memory installed and the available memory slots in the system. Information from the database is then augmented with this additional information to make a more specific memory upgrade recommendation. For example, the database will indicate whether the user system is compatible with synchronous dynamic random access memory (SDRAM) or double data rate SDRAM (DDR) and scan data will indicate the number of available memory slots.

Rules and the Recommendation Engine

As discussed with respect to FIGS. 5B-5C above, the scan data or posted data is processed through the recommendation engine to determine a proper memory upgrade recommendation for the customer's system. According to various embodiments, a series of rules are implemented in the recommendation engine program code to ensure an accurate upgrade recommendation. At least two types of rules are utilized in the present system, according to various embodiments. The first type of rules, gathering rules, were discussed previously regarding the use of the scanner module. The second type of rules, presentation rules, are used in the recommendation engine.

FIG. 6 illustrates a flow diagram of a method for making a memory upgrade recommendation, according to various embodiments. The flow diagram depicts various input options and how an application 608 for processing presentation rules acts upon the various inputs to produce a memory recommendation 610. These presentation rules are designed to reflect the advice a technical expert would provide a particular user based on the inputs. The inputs include an optional user input 602, the scan data 604 and the memory selector information 606. User input 602 includes responses to questions posed to the user via the user web browser, including how the user uses the computer. According to various embodiments, the user is provided with a number of broad categories such as light administrative work, heavy office work, graphic design and computer games from which to choose. Other user input includes information gathered from the referring URL and other input from selections of drop down menus, according to various embodiments.

Scan data 604, as previously described, includes SMBIOS data, SPD data and operating system data, in various embodiments. Scan data can provide information such as number of empty memory slots, exact type of memory already installed in the user system, and the specific version of the user operating system. Memory selector information 606 includes data stored in the database, discussed below with respect to FIG. 7. The presentation rules attempt to associate user input and scan data to a specific computer or motherboard model in the memory selector database.

According to various embodiments, scan data is used to update the recommendation engine. According to one embodiment, scan data is used to identify new machines or manufactures to allow the rules for the recommendation engine to be updated to include these new machines and manufacturers.

According to various embodiments, rule processing is used to create a series of rules to address specific combinations received from input sources. According to various embodiments, rule processing falls into four broad categories: hardware compatibility, hardware capability, hardware recommendation, and presentation. Hardware compatibility rule processing combines scanner data with memory selector information to prevent the recommendation of an incompatible memory upgrade. For example, a particular user system may be compatible with both registered and non-registered DIMM modules, but may not allow a mixture of registered and not-registered DIMMs to be installed. A hardware compatibility rule checks what type of modules are currently installed and eliminates non-compatible choices.

Hardware capability rule processing serves as a filtering mechanism to remove possible upgrade choices that do not maximize upgrade potential. For example, a given user system with two memory slots may be compatible with 128 MB, 256 MB and 512 MB memory modules. If one of the slots is already filled with a 128 MB module and the user is running Windows XP (which works best with at least 512 MB of memory), the rule would eliminate the 128 MB and 256 MB modules from the list of possible recommendations and recommend a 512 MB module.

Hardware recommendation rule processing responds primarily to user input 602. Generally, user input would map the user's scan data to a predefined hardware profile. According to various embodiments, the hardware recommendation rule would then compare the customer's existing memory configuration to the ideal configuration stored in the predefined profile and create a recommendation based on that comparison. For example, if a user has indicated the system is used for gaming, and the gamer profile recommends 1 GB of memory but the scan shows 256 MB of memory with two open slots, and the memory selector information indicates the user system has a max capacity of 1.5 GB with 512 MB modules as the largest compatible module, the hardware recommendation rule would recommend purchasing two 512 MB memory modules to make the computer a capable gaming system.

Presentation rule processing involves modifying the presentation of the memory recommendation. For example, installing more than 256 MB of memory on a computer running Windows 98, Windows 98SE, Windows 95 or Windows ME requires changing a setting in Windows. When the scanner detects one of these versions of Windows and makes a memory upgrade recommendation that will take the user system beyond 256 MB, this rule will display a warning on the recommendation page and provide instructions to adjust the Windows setting.

Database

As mentioned, the goal of the recommendation engine is to match the user input (if provided) and the scan data to a computer system already defined in an internal database. According to various embodiments, the internal database contains make, model and motherboard information for a large number of computer systems (e.g. 25,000). The database was developed as part of a memory selector tool, which provides memory recommendations based on user input only, without scanning the user system. The memory selector database not only tracks which specific memory modules have been validated with a given computer or motherboard, but also tracks unusual compatibility issues for certain models. For example, a particular user system may have three memory slots and a maximum memory capacity of 1.5 GB, but if all three slots are used the system requires that all three modules be registered DIMMs. If less than all the slots are filled, the same system may not require registered DIMMs.

FIG. 7 illustrates a schematic diagram of a representational view of a database used in the recommendation engine application, according to various embodiments. In one embodiment, the database contains scanner tables 701 and hardware data tables 717. According to various embodiments, hardware data tables 717 include a computer manufacturer table 719, a computer model table 721, a model-to-module table 723 and a memory module table 725. According to various embodiments, scanner tables 701 include a scan table 703, a scan system table 705, a scan unresolved table 707, a field map table 709, and rules logic tables 711 including a rule set table 713 and a rule table 715. According to the illustrated embodiment, the database is a relational database. Those skilled in the art will recognize that primary keys (PK) and foreign keys (FK) are used the relational database to share information between tables, as depicted in FIG. 7.

According to various embodiments, scan table 703 includes the scan ID and customer information such as browser type, chosen settings, and whether the user launched the scanner from the memory selector pages. The scan system table 705 includes attributes for each system scanned, such as physical memory, computer system, motherboard, and SMBIOS data. The scan unresolved table 707 keeps track of all scans that have not been mapped, so that these scans can be mapped manually. The scan table 703, scan system table 705, and scan unresolved table 707 are linked for a particular user. The field map table 709 stores the mapping of the scan and contains information on the identification of how the system resolved, which may include rules used and manufacturer, model or base part identification. The rules logic tables 711 denote a set of tables that encompass the rules logic. This includes matching rules, profile rules, and exception rules. The action type shows how the rule would act on particular data, for example looking to another rule to match a specific model.

According to one embodiment, the recommendation engine provides a memory upgrade recommendation without using a database for reference. In this embodiment, the recommendation engine would base the recommendation on previous scans of similar or identical systems.

Output

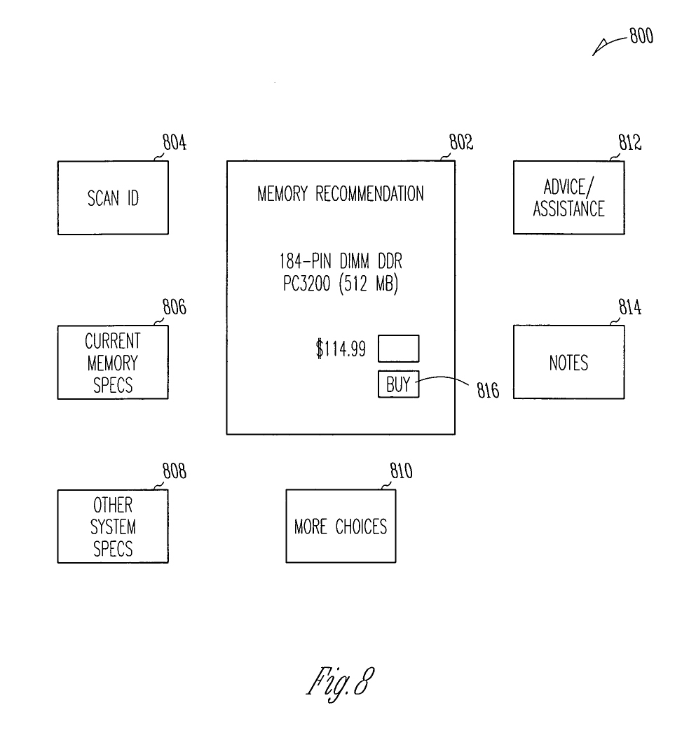

FIG. 8 illustrates a screen display for the browser-based system of FIG. 1, used to display a recommendation for a specific memory upgrade, according to various embodiments. As previously disclosed, in one embodiment the recommendation engine outputs a memory upgrade recommendation 802 on a web page 800 to the user's browser. According to various embodiments, the output is in HTML. In the illustrated embodiment, the output webpage 800 also contains the scan ID 804, the current memory specification 806 of the user system, other system specifications 808 of the user system, more choices 810 or options for memory upgrades, advice and assistance on upgrading memory 812, and notes 814 to the user. An example of a note 814 to the user would be to inform them that although memory can be installed one module at a time, the best performance comes from using matched pairs of modules. The memory recommendation 802 includes the specifications and cost. In addition, the system allows the client or customer to purchase the recommended hardware directly from the web page displaying the recommendation, shown as a “Buy” button 816 on the web page.

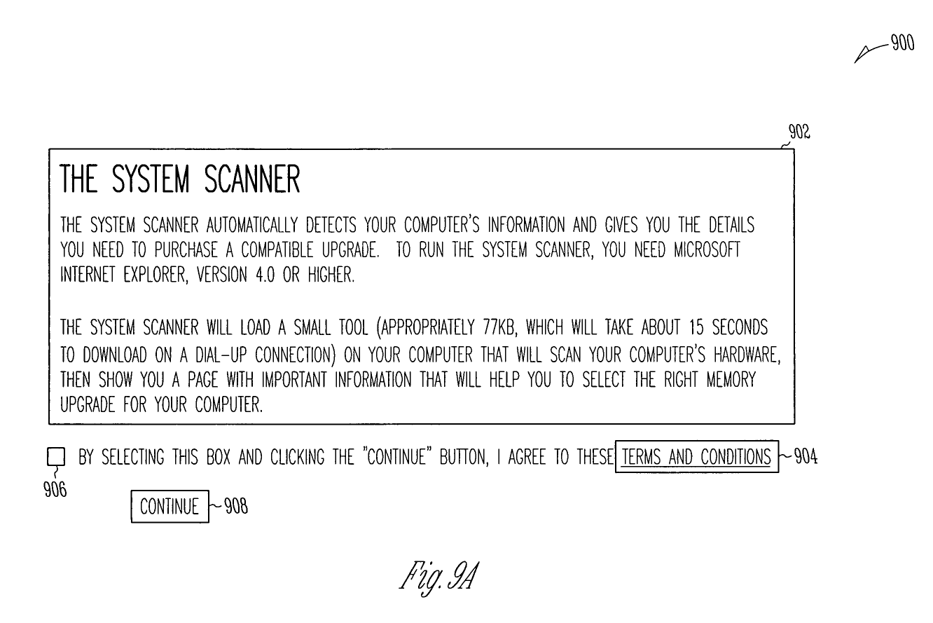

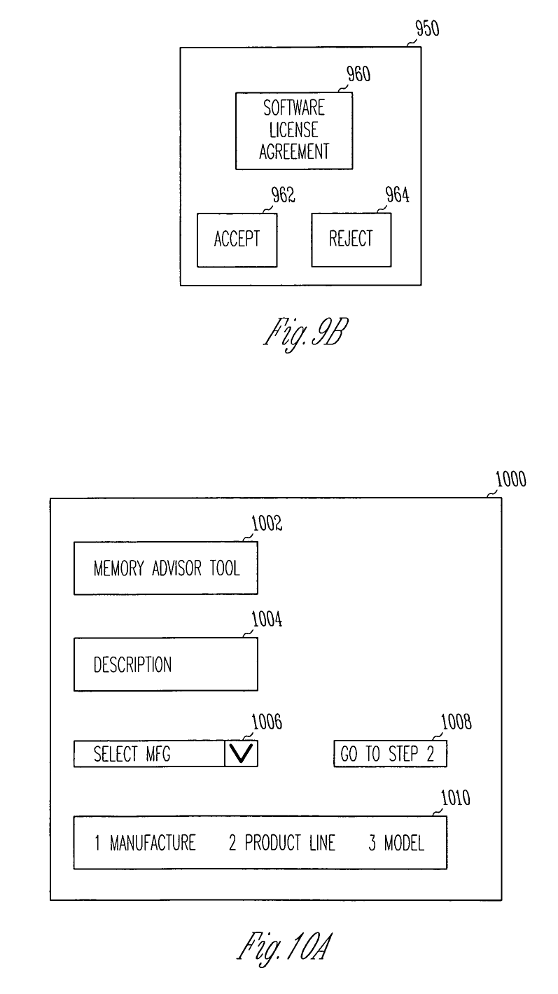

FIG. 9A illustrates a screen display for the browser-based system of FIG. 1, used by a customer to directly request a scan, according to various embodiments. According to various embodiments, this web page 900 includes a description 902 of the attributes of the scanner system, including its size and download time, and requests the user review and agree with the terms and conditions for using the scanner. The web page 900 includes a link 904 to view the terms and conditions and a selector box 906 to check if the user agrees with the terms and conditions. In the illustrated embodiment, a link 908 allows the customer to continue with the scan after agreeing to the terms and conditions.

FIG. 9B illustrates a screen display for the browser-based system of FIG. 1, used to request customer acceptance of the scanner license agreement, according to various embodiments. According to various embodiments, this web page 950 is displayed when a user uses link 904 of FIG. 9A. According to the illustrated embodiment, this web page 950 displays the system scanner license agreement 960 and provides buttons for the user to accept 962 or reject 964 the agreement before proceeding with the download of the scanner.

Memory Advisor Tool

As previously disclosed, the memory selector (aka memory advisor) tool is an application which provides memory recommendations based on user input only, without scanning the user system. The memory selector database is used by the recommendation engine to compare scan data in determining an upgrade recommendation. In addition, as mentioned with respect to the flow diagram FIG. 5B above, the recommendation engine builds user profiles if the scanner was launched from the memory selector page. Examples of the memory selector pages are shown in FIGS. 10A through 10C.

FIG. 10A illustrates a screen display for the browser-based system of FIG. 1, used to request customer system manufacturer information for a memory advisor tool, according to various embodiments. According to various embodiments, this web page 1000 is the first web page of the memory advisor, and includes a title 1002, a description 1004 of what the memory advisor is and how it works, and other information 1010. According to the illustrated embodiment, the web page 1000 allows a user to select their manufacturer from a drop down menu 1006 and provides a link 1008 to proceed to the next step in the memory advisor process, shown in FIG. 10B.

FIG. 10B illustrates a screen display for the browser-based system of FIG. 1, used to request customer system product line information for a memory advisor tool, according to various embodiments. According to various embodiments, this web page 1020 is the second step of the memory advisor and includes a title 1022. According to the illustrated embodiment, the user is allowed to select their product line from a drop down menu 1026 and a link 1028 is provided to proceed to the next step in the memory advisor process, shown in FIG. 10C. In addition, this web page provides a description 1030 of the scanner application and provides a link 1032 for the user to request a download of the scanner. As previously described, the scanner can be launched prior to or during use of the memory advisor tool. Also, this web page provides a link 1034 to ask a question of an online expert as well as a link 1036 to a frequently asked question (FAQ) center.

FIG. 10C illustrates a screen display for the browser-based system of FIG. 1, used to request customer system model information for a memory advisor tool, according to various embodiments. According to various embodiments, this web page 1040 is the third and final step of the memory advisor and includes a title 1042. According to the illustrated embodiment, the user is allowed to select their model from a drop down menu 1046 and a link 1048 is provided to proceed to obtain a memory upgrade recommendation based solely on their inputs. In addition, this web page provides a description 1050 of the scanner application and provides a link 1052 for the user to request a download of the scanner. Also, this web page provides a link 1054 to ask a question of an online expert as well as a link 1056 to a frequently asked question (FAQ) center.

This disclosure includes several processes, diagrams, and structures. The present invention is not limited to a particular process order or logical arrangement. Although specific embodiments have been illustrated and described herein, it will be appreciated by those of ordinary skill in the art that any arrangement which is calculated to achieve the same purpose may be substituted for the specific embodiment shown. This application is intended to cover adaptations or variations, and includes any other applications in which the above structures and fabrication methods are used. It is to be understood that the above description is intended to be illustrative, and not restrictive. Combinations of the above embodiments, and other embodiments, will be apparent to those of skill in the art upon reviewing the above description. The scope of the present invention should be determined with reference to the appended claims, along with the full scope of equivalents to which such claims are entitled.

What is claimed is:

1. A method, comprising:
scanning a computer system to determine scan data, including type of computer system, number of available memory slots and amount of existing Dynamic Random Access Memory (DRAM); and
recommending a specific DRAM upgrade for the computer system based on the scan data.

2. The method of claim 1 wherein recommending the specific DRAM upgrade includes displaying a recommendation on a web page on the computer system.

3. The method of claim 1 wherein scanning a computer system includes downloading a scanning program using a web browser on the computer system.

4. The method of claim 1 wherein scanning a computer system includes reading data in a system management basic input output system (SMBIOS) of the personal computer system.

5. The method of claim 1 wherein recommending a specific DRAM upgrade for the computer system includes comparing the scan data to data in a memory upgrade database relating to the type of computer system.

6. The method of claim 1 wherein scanning a computer system includes initiating an ActiveX control downloaded from a web server.

7. The method of claim 6 wherein scanning a computer system includes initiating a program to execute on a Windows Management Interface (WMI) of the computer system.

8. A method, comprising:
allowing a user of a personal computer system to download a scanner application using a web browser on the personal computer system;
reading scan data from the personal computer using the scanner application;
formatting the scan data;
encrypting the scan data;
returning the scan data to a hosting web server;
processing the scan data using a recommendation engine; and
outputting a computer memory upgrade recommendation to the user's browser.

9. The method of claim 8 wherein reading the scan data includes reading SMBIOS data from the personal computer.

10. The method of claim 8 wherein formatting the scan data includes placing the scan data in a format compatible with a markup language.

11. The method of claim 10 wherein formatting the data includes placing the scan data in a format compatible with extensible markup language (XML).

12. The method of claim 8 wherein outputting the computer memory upgrade recommendation includes displaying a web page to the user's browser.

13. The method of claim 8 wherein outputting the computer memory upgrade recommendation includes outputting in hyper text markup language (HTML).

14. The method of claim 8 wherein processing scan data through a recommendation engine includes comparing scan data to a database of system memory upgrade data.

15. A computer-readable medium encoded with a software program for recommending a specific Dynamic Random Access Memory (DRAM) upgrade, the software program executing the following:
providing an application adapted to scan a personal computer system to determine scan data; and
displaying a web page on the personal computer containing a recommendation for a specific DRAM upgrade for the computer system based on the scan data.

16. The computer-readable medium of claim 15 wherein the scan data includes data indicative of type of personal computer system.

17. The computer-readable medium of claim 15 wherein the scan data includes data indicative of make of the personal computer system.

18. The computer-readable medium of claim 15 wherein the scan data includes data indicative of model of the personal computer system.

19. The computer-readable medium of claim 15 wherein the scan data includes data indicative of a number of available memory slots of the personal computer system.

20. The computer-readable medium of claim 15 wherein the scan data includes data indicative of an amount of existing DRAM of the personal computer system.

21. The computer-readable medium of claim 15 wherein the providing an application includes providing a control to examine SMBIOS information of the personal computer system.

22. A method, comprising:
accepting a user input to request a system scan;
providing a control to the user to scan a user system;
receiving results of the scan of the user system; and
recommending an upgrade of the user system based on the scan.

23. The method of claim 22 wherein accepting a user input to request a system scan includes receiving input from a web browser.

24. The method of claim 22 further comprising receiving information from the user regarding manufacturer and model of the user system as selected from a drop down menu on a web page, prior to accepting a user input to request a system scan.

25. The method of claim 22 wherein providing a control to the user to scan a user system includes launching an ActiveX control downloaded from a web server.

26. The method of claim 22 wherein providing a control to the user includes launching a stand-alone executable program.

27. The method of claim 22 further comprising generating a scan identification number, prior to accepting a user input to request a system scan.

28. The method of claim 27 further comprising associating a customer launch profile to the scan identification number.

29. A method, comprising:
receiving data scanned from a personal computer;
searching the scanned data for indicia of model, motherboard and chipset of the personal computer;
processing the scanned data to generate a recommendation for a specific upgrade for the personal computer; and
outputting the recommendation.

30. The method of claim 29 wherein processing the data includes comparing data scanned to data in a database to determine if a model match recommendation exists.

31. The method of claim 29 wherein processing the data includes comparing data scanned to data in a database to determine if a motherboard match recommendation exists.

32. The method of claim 29 wherein processing the data includes comparing data scanned to data in a database to determine if a chipset match recommendation exists.

33. The method of claim 29 wherein outputting the recommendation includes displaying a web page containing the recommendation on the personal computer.

34. The method of claim 29 wherein outputting the recommendation includes displaying a web page informing that no match could be found.

35. The method of claim 29 wherein outputting the recommendation includes returning the recommendation via hyper text markup language (HTML) to a web browser on the personal computer.

36. A computer-readable medium encoded with a software program, the software program adapted to execute the following:
accepting a user input to request a system scan;
initiating a first process to scan a user system to determine a first representation of scan data;
initiating a second process to scan a user system to determine a second representation of scan data; and
outputting the first and second representations of scan data.

37. The computer-readable medium of claim 36 wherein the first process to scan a user system includes initiating a program to retrieve data from SMBIOS.

38. The computer-readable medium of claim 36 wherein the second process to scan a user system includes initiating a program to execute an assembly code routine.

39. The computer-readable medium of claim 36 wherein the second process to scan a user system is a backup to the first process.

40. The computer-readable medium of claim 36 wherein the second process is adapted to obtain scan data from a user system without accessing SMBIOS.

41. The computer-readable medium of claim 36 wherein returning the scan data includes placing the scan data in a format compatible with extensible markup language (XML).
